(19) United States
(12) Patent Application Publication
(10) Pub. No.: US 2019/0202291 A1
(43) Pub. Date: Jul. 4, 2019

(54) VEHICLE OPERATION SYSTEM AND NON-TRANSITORY TANGIBLE COMPUTER READABLE STORAGE MEDIUM

(71) Applicant: DENSO CORPORATION, Kariya-city (JP)

(72) Inventors: Daisuke SUZUKI, Kariya-city (JP); Kazutomo TSUCHIKAWA, Kariya-city (JP); Yoshinori WATANABE, Kariya-city (JP); Taiichiro ICHIMARU, Kariya-city (JP); Daisuke NAMEKAWA, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 16/296,289

(22) Filed: Mar. 8, 2019

Related U.S. Application Data
(63) Continuation of application No. PCT/JP2017/023969, filed on Jun. 29, 2017.

(30) Foreign Application Priority Data
Sep. 12, 2016 (JP) 2016-177608

(51) Int. Cl. B60K 37/02; B60K 35/00

(52) U.S. Cl. CPC B60K 37/02; B60K 2350/352; B60K 2350/1016; B60K 35/00

(57) ABSTRACT

A vehicle operation system that controls a control target device based on a predetermined operation of a driver on a steering wheel of a vehicle is provided. The vehicle operation system may calculate a gripping position at which the driver grips the steering wheel. The vehicle operation system may calculate a display position on a display using a calculation result of the gripping position calculation unit and a position coordinate of the steering wheel. The display is arranged farther than the steering wheel from a visual line position of the driver. The display position is not hidden behind a hand of the driver and the steering wheel. The vehicle operation system may display display information indicating a content of the operation on the steering wheel at the display position.

### CROSS REFERENCE TO RELATED APPLICATIONS

The present application is a continuation application of International Patent Application No. PCT/JP2017/023969 filed on Jun. 29, 2017, which designated the United States and claims the benefit of priority from Japanese Patent Application No. 2016-177608 filed on Sep. 12, 2016. The entire disclosures of all of the above applications are incorporated herein by reference.

### TECHNICAL FIELD

The present disclosure relates to a vehicle operation system and a non-transitory tangible computer readable storage medium.

### BACKGROUND

A vehicle operation system that controls a control target device based on a predetermined operation of a driver on a steering wheel of the vehicle has been proposed.

### SUMMARY

A vehicle operation system may calculate a display position on a display not hidden behind a hand of a driver and a steering wheel using a calculation result of a gripping position at which the driver grips the steering wheel and a position coordinate of the steering wheel.

### BRIEF DESCRIPTION OF DRAWINGS

The above and other objects, features and advantages of the present invention will become more apparent from the following detailed description made with reference to the accompanying drawings. In the drawings:

FIG. 1 is a functional block diagram showing one embodiment;

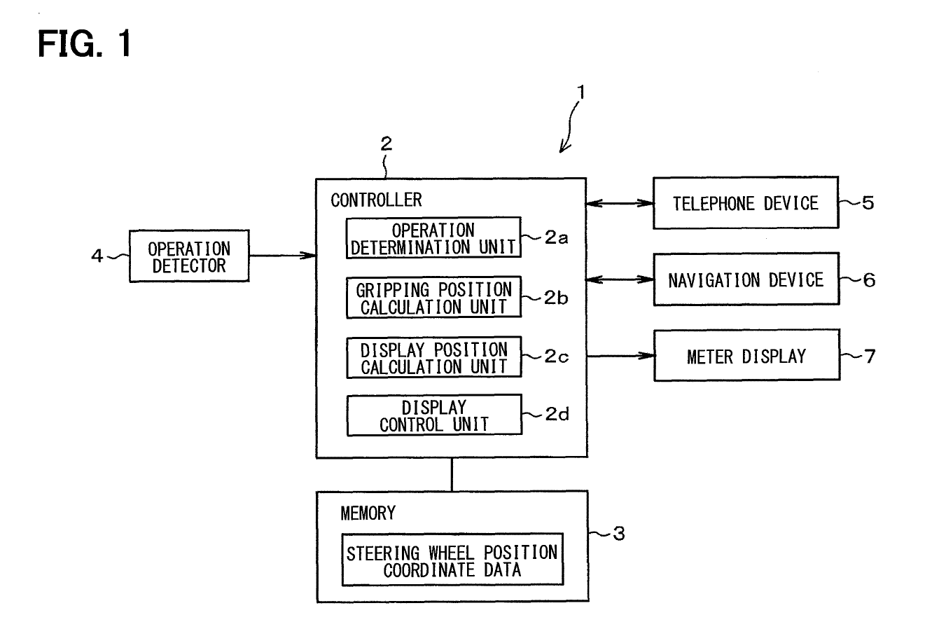

FIG. 2 is a diagram showing a configuration of the periphery of a steering wheel and a meter display;

FIG. 3 is a diagram (part 1) showing a display mode of display information;

FIG. 4 is a flowchart;

FIG. 5 is a diagram (part 2) showing a display mode of the display information;

FIG. 6 is a diagram (part 3) showing a display mode of the display information;

FIG. 7 is a diagram (part 4) showing a display mode of the display information;

FIG. 8 is a diagram (part 5) showing a display mode of the display information;

FIG. 9 is a diagram (part 6) showing a display mode of the display information; and

FIG. 10 is a diagram (part 7) showing a display mode of the display information.

### DETAILED DESCRIPTION

For example, a vehicle operation system that controls a control target device based on a predetermined operation of a driver on a steering wheel of the vehicle has been proposed. In this type of vehicle operation system, display information (that is, an icon or the like) indicating the content of the operation on the steering wheel is displayed on, for example, a head up display or the like so that the driver can visually recognize the content of the operation. By visually recognizing the display information and performing the predetermined operation on the steering wheel, the driver can perform, for example, various settings of the audio device and the air conditioner at the periphery of the steering wheel with less visual line movement from the front of the vehicle.

As a predetermined operation performed by the driver on the steering wheel, an operation of pressing the steering wheel with a finger without changing the gripping position at which the driver grips the steering wheel is assumed. In this case, it is desirable to display the display information near the gripping position at which the driver grips the steering wheel. When the display position of the display information is fixed, the following difficulty is assumed. That is, for example, when the driver changes the gripping position during driving by releasing the steering wheel and then holding the steering wheel again, sliding the hand along the steering wheel, or the like, there is a possibility that the display information is hidden behind the hand seen from the visual line of the driver (that is, the position of the eyes). Thus, in such a situation, a labor for returning the hand of the driver to the first gripping position in order to causes the driver to visually recognize the display information, that is, a labor for releasing the steering wheel again then holding the steering wheel, sliding the hand again along the steering wheel, or the like may occur, which is troublesome. Especially when the vehicle speed is relatively fast, it is assumed that the labor of releasing the hand from the steering wheel and then griping the steering wheel again, or sliding the hand along the steering wheel will be hesitated.

An example embodiment of the present disclosure provides a vehicle operation system and a non-transitory tangible computer readable storage medium each of which enables the driver to appropriately and visually recognize display information indicating a content of an operation on the steering wheel, and improves convenience for the driver even when the gripping position at which the driver grips the steering wheel is changed

In an example embodiment of the present disclosure, in a vehicle operation system that controls a control target device based on a predetermined operation of a driver on a steering wheel of a vehicle, a gripping position calculation unit calculates a gripping position at which the driver grips the steering wheel. A display position calculation unit calculates a display position on a display using a calculation result of the gripping position calculation unit and a position coordinate of the steering wheel. The display is arranged farther than the steering wheel from a visual line position of the driver. The display position is not hidden behind a hand of the driver and the steering wheel. A display control unit displays display information indicating a content of the operation on the steering wheel at the display position.

In the above-described configuration, the display position on the display not hidden behind the hand of the driver and the steering wheel is calculated using the calculation result of the gripping position at which the driver grips the steering wheel and the position coordinate of the steering wheel. With this configuration, the display information indicating the content of the operation on the steering wheel at the display position is displayed at the display position. Even when the gripping position at which the driver grips the steering wheel is changed, the driver can appropriately and visually recognize the display information indicating the content of the operation on the steering wheel, and improve convenience for the driver.

Hereinafter, an embodiment will be described with reference to the drawings. The vehicle operation system 1 includes a controller 2, a memory 3, an operation detector 4, a telephone device 5 (corresponding to a control target device), a navigation device 6 (corresponding to a control target device), and a meter display 7 (corresponding to a display).

The operation detector 4 includes an electrostatic sensor arranged in a steering wheel 8 in the passenger compartment. The operation detector 4 detects a gripping position at which the driver grips the steering wheel 8 and the operation of the driver on the steering wheel 8. The operation detector 4 transmits an operation detection signal indicating the detected gripping position and the detected operation of the driver to the controller 2. The operation detector 4 may include any sensor as long as the detector 4 is capable of detecting the gripping position and the operation of the driver. The operation detector 4 may include a light sensor, a temperature sensor, a pressure sensor, or the like.

The telephone device 5 is a device having a telephone function. The telephone device 5 transmits a call detection signal to the controller 2 when detecting an incoming call from the communication network. When receiving an answer signal from the controller 2, the telephone device 5 performs control to answer the incoming call. When receiving a hold signal from the controller 2, the telephone device 5 performs control to hold the incoming call. The telephone device 5 may be an on-vehicle telephone installed and fixed in a vehicle. Alternatively, the telephone device 5 may be a simplified mobile phone capable of being brought into the passenger compartment by the driver, or a multifunctional mobile phone defined as a smartphone. In case of the mobile phone capable of being brought into the passenger compartment by the driver, the mobile phone is connected to the controller 2 via Bluetooth (registered trademark), thereby inputting various signals from the controller 2, and performing various controls.

The navigation device 6 has a function of identifying the position of the vehicle, a function of executing map matching to the vehicle on the map, a function of setting a destination, and a function of searching a route from the vehicle position to the destination. In addition, the navigation device 6 has a proposal function. The navigation device 6 transmits a proposal signal to the controller 2 when a proposal condition is satisfied. The proposal function may be a function to propose a content which urges the driver to take a break. For example, the navigation device 6 transmits the proposal signal that urges the driver to take a brake to the controller 2 when the driver's continuous operation time reaches a predetermined time.

When receiving a positive response signal from the controller 2, the navigation device 6 performs a positive response control in response to the positive response signal. When receiving a negative response signal from the controller 2, the navigation device 6 performs a positive response control in response to the negative response signal. The navigation device 6 may propose the content which urges the driver to take a break. In this case, when receiving the positive response signal from the controller 2, the navigation device 6 searches for and presents a route to a rest place with respect to a proposal urging the driver to take a break and calculates and presents the expected arrival time. When receiving the negative response signal from the controller 2, the navigation device 6 discards the proposal urging the break.

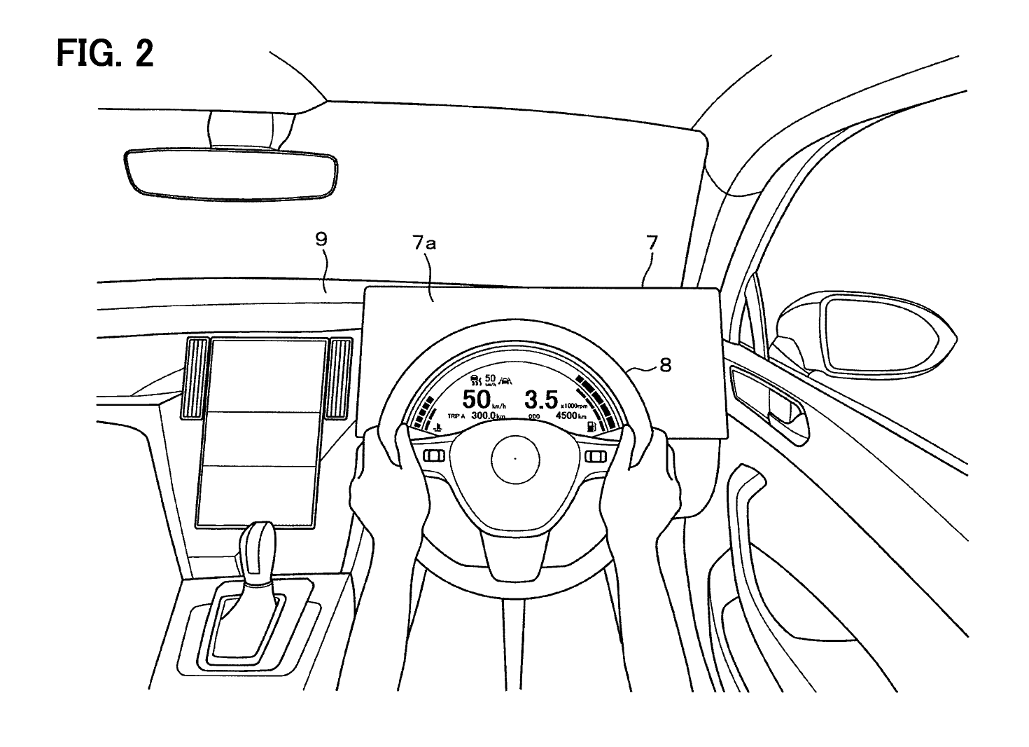

As shown in FIG. 2, the meter display 7 is arranged between the steering wheel 8 and the dashboard 9 in the passenger compartment. Seen from the visual line of the driver, the meter display 7 is disposed farther than the steering wheel 8. In the meter display 7, most of the planar portion on the side of the steering wheel 8, that is, the planar portion on which the driver can visually recognize is set as the display area 7a. When a display command signal is received from the controller 2, the information designated by the display command signal is displayed in the display area 7a. The information displayed in the display area 7a of the meter display 7 may be the vehicle speed, the engine rotation speed, the cumulative travel distance, the fuel amount, the image of the electronic mirror system, or the like.

The controller 2 is constituted by a microcomputer having a CPU (Central Processing Unit), a ROM (Read Only Memory), a RAM (Random Access Memory), and an I/O device (Input/Output device). The controller 2 executes a computer program stored in a non-transitory tangible storage medium to execute a processing corresponding to the computer program, and controls the overall operation of the vehicle operation system 1. The memory 3 stores position coordinate data indicating the three-dimensional position coordinate of the steering wheel 8. That is, when the driver adjusts the position of the steering wheel 8, the memory 3 updates the position coordinate data indicating the three-dimensional position coordinate before adjustment to the position coordinate data indicating the three-dimensional position coordinate after adjustment.

The controller 2 includes an operation determination unit 2a, a gripping position calculation unit 2b, a display position calculation unit 2c, and a display control unit 2d. Each of these units 2a to 2d is provided by a computer program executed by the controller 2, and is achieved by software.

When receiving the operation detection signal from the operation detector 4, the operation determination unit 2a determines the operation of the driver on the steering wheel 8 based on the input operation detection signal, and transmits the control signal to the telephone device 5 and the navigation device 6 based on the determination result. That is, the driver may be capable of selecting to answer or hold the incoming call (that is, any one of the multiple selection operations) from the communication network to the telephone device 5. In this case, when determining that the driver operation is to answer the incoming call based on the operation detection signal, the operation determination unit 2a transmits the answer signal to the telephone device 5. When determining that the driver operation is to hold the incoming call based on the operation detection signal, the operation determination unit 2a transmits the hold signal to the telephone device 5. The driver may be capable of selecting to agree or disagree with the proposal (that is, any one of the multiple selection operations) from the navigation device 6. In this case, when determining that the driver operation is the positive response to the proposal based on the operation detection signal, the operation determination unit 2a transmits the positive response signal to the navigation device 6. When determining that the driver operation is the negative response to the proposal based on the operation detection signal, the operation determination unit 2a transmits the negative response signal to the navigation device 6.

When receiving the operation detection signal from the operation detector 4, the gripping position calculation unit 2b calculates the gripping position at which the driver grips the steering wheel 8 based on the received operation detection signal.

The display position calculation unit 2c calculates the display position on the meter display 7 so that the display position is not hidden behind the driver's hands and the steering wheel 8 in view of the driver's visual line position using the calculation result of the gripping position calculation unit 2b and the position coordinate data stored in the memory 3. The display control unit 2d transmits a display start command signal to the meter display 7, starts displaying the display information on the meter display 7 indicating the operation content on the steering wheel 8, transmits a display termination command signal to the meter display 7, and terminates displaying the display information on the meter display 7.

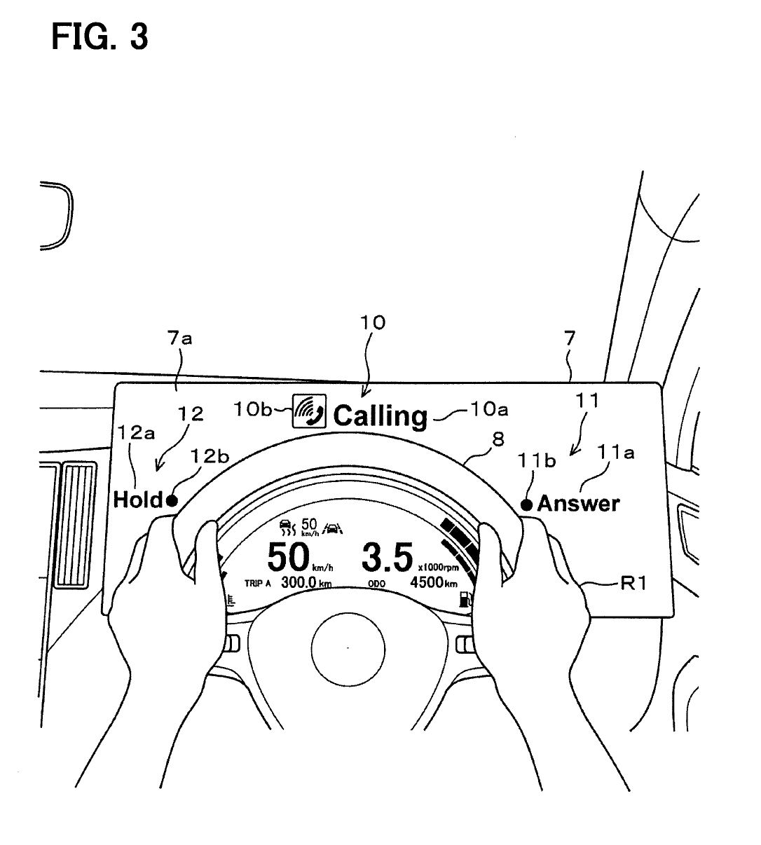

The controller 2 may receive the call detection signal from the telephone device 5 in the above-described configuration. In this case, as shown in FIG. 3, display information 10 (a character string 10a of “Calling”, and an icon 10b) indicative of the incoming call is displayed at a position corresponding to above the steering wheel 8 in the display area 7a of the meter display 7. The display information 11 (a character string 11a of “Answer”, and an icon 11b) indicative of the answer is displayed on the right of the steering wheel 8, that is, at a position corresponding to the upper right of the steering wheel 8 in the display area 7a of the meter display 7. The display information 12 (a character string 12a of “Hold”, and an icon 12b) indicative of the hold is displayed on the left of the steering wheel 8, that is, at a position corresponding to the upper left of the steering wheel 8 in the display area 7a of the meter display 7.

In the state shown in FIG. 3, when the controller 2 receives the operation detection signal from the operation detector 4 and determines that the driver presses the steering wheel 8 with the right hand's finger, the controller 2 determines that the driver selects the answer and transmits the answer signal to the telephone device 5. On the other hand, when the controller 2 receives the operation detection signal from the operation detector 4 and determines that the driver presses the steering wheel 8 with the left hand's finger, the controller 2 determines that the driver selects the hold and transmits the hold signal to the telephone device 5.

In such a mode displaying the display information 11, 12 on the meter display 7, when the driver changes the gripping position of the steering wheel 8 during driving, there is a possibility that the display information is hidden behind the driver's hand seen from the driver's visual line position. Thus, in order that the driver visually recognizes the display information, the driver may release the steering wheel 8 and then hold the steering wheel 8 again or slide the hand along the steering wheel. Regarding this point, the controller 2 performs the following control.

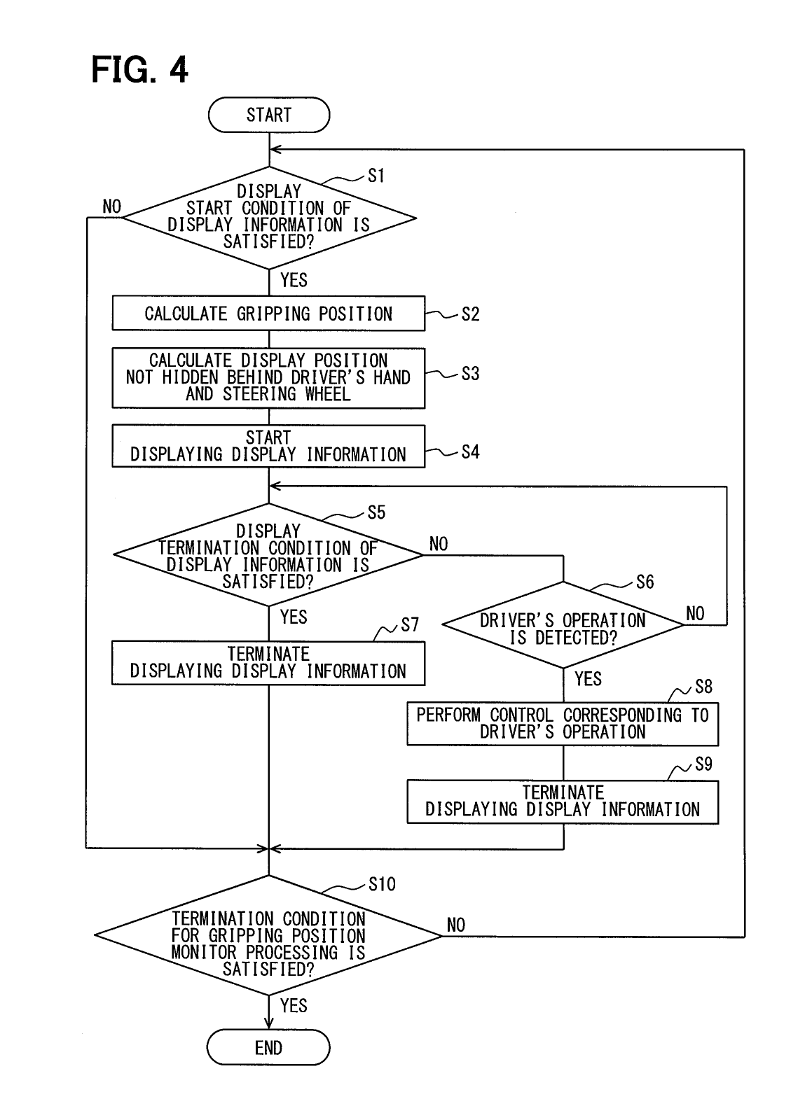

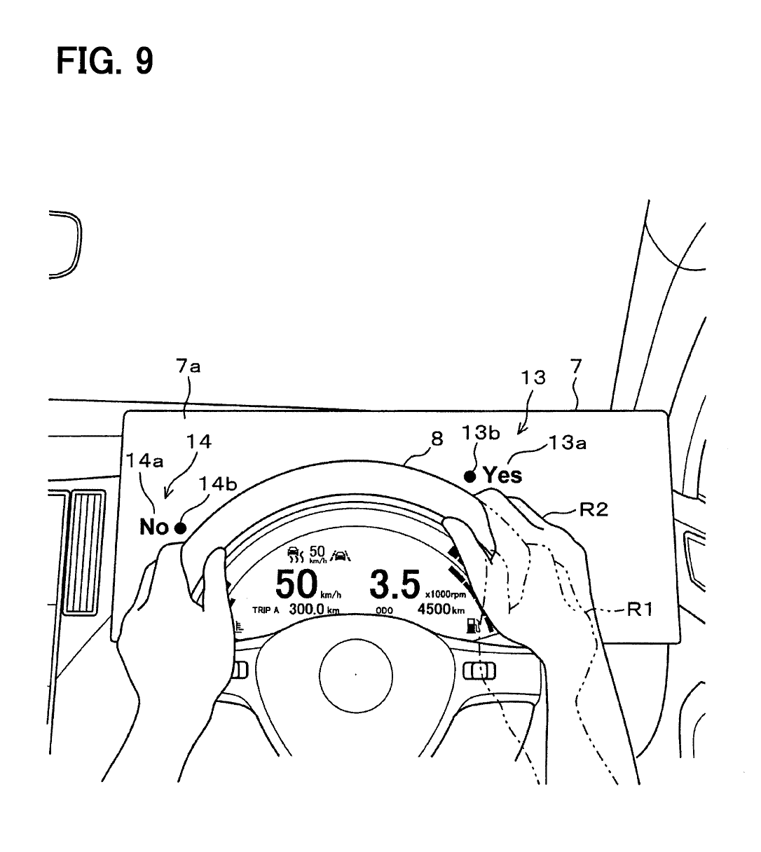

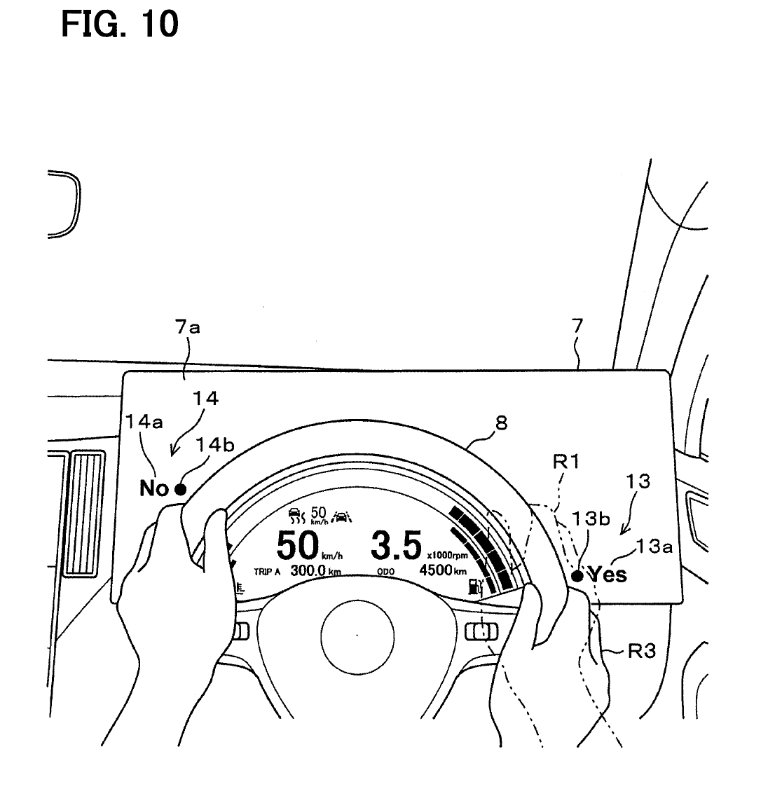

Next, the processing of the above configuration will be described with reference to FIGS. 4 to 10. The controller 2 performs a gripping position monitor processing which controls the display position of the display information 11, 12 corresponding to the gripping position at which the driver grips the steering wheel 8. When the start condition of the gripping position monitor processing such as the switching of the accessory switch from an off state to an on state is satisfied, the controller 2 starts the gripping position monitor processing. When the gripping position monitor processing is started, the controller 2 determines whether the display start condition of the display information is satisfied (S1). When the controller 2 determines that the display start condition of the display information is not satisfied (S1: NO), the controller 2 determines whether the termination condition of the gripping position monitor processing is satisfied (S10).

On the other hand, when determining that the call detection signal has been received from the telephone device 5 and the display start condition of the display information is satisfied (S1: YES), the controller 2 calculates the gripping position at which the driver grips the steering wheel 8 based on the operation detection signal received from the operation detector 4 (S2, corresponding to a gripping position calculation procedure). The controller 2 calculates the display position on the meter display 7 so that the display position is not hidden behind the driver's hand and the steering wheel 8 in view of the driver's visual line position using the calculation result of the gripping position and the position coordinate of the steering wheel 8 (S3, corresponding to a display position calculation procedure). The controller 2 transmits the display start command signal to the meter display 7, and starts displaying the display information on the meter display 7 (S4, corresponding to a display control procedure) as shown in FIG. 3 described above. With this configuration, the driver can visually recognize the display information 11, 12. The driver can recognize that the right hand is to be used for the operation when answering the incoming call, and the left hand is to be used for the operation when holding the incoming call.

The controller 2 determines whether the display termination condition is satisfied (S5), and determines whether the operation of the driver is detected (S6). Suppose that the controller 2 may determine that the display termination condition is satisfied due to the cancellation of the incoming call before the operation of the driver is detected (S5: YES). In this case, the controller 2 transmits the display termination command signal to the meter display 7, terminates the display of the display information on the meter display 7 (S7), and determines whether the termination condition of the gripping position monitor processing is satisfied (S10).

On the other hand, suppose that the controller 2 may determine that the operation of the driver is detected before the display termination condition of the display information is satisfied (S6: YES). In this case, the controller 2 performs the control corresponding to the driver's operation (S8). That is, when determining that the driver has performed the answer operation based on the operation detection signal received from the operation detector 4, the controller 2 transmits the answer signal to the telephone device 5 and controls the telephone device 5 to answer the incoming call. On the other hand, when determining that the driver has performed the hold operation based on the operation detection signal received from the operation detector 4, the controller 2 transmits the hold signal to the telephone device 5 and controls the telephone device 5 to hold the incoming call. The controller 2 transmits the display termination command signal to the meter display 7, terminates displaying the display information on the meter display 7 (S9), and determines whether the termination condition of the gripping position monitor processing is satisfied (S10).

When the controller 2 determines that the termination condition of the gripping position monitor processing is not satisfied (S10: NO), the procedure returns to step S1 and repeatedly executes the following operations from step S1. When the termination condition of the gripping position monitor processing such as the switching of the accessory switch from the on state to the off state is satisfied (S10: YES), the controller 2 terminates the gripping position monitor processing.

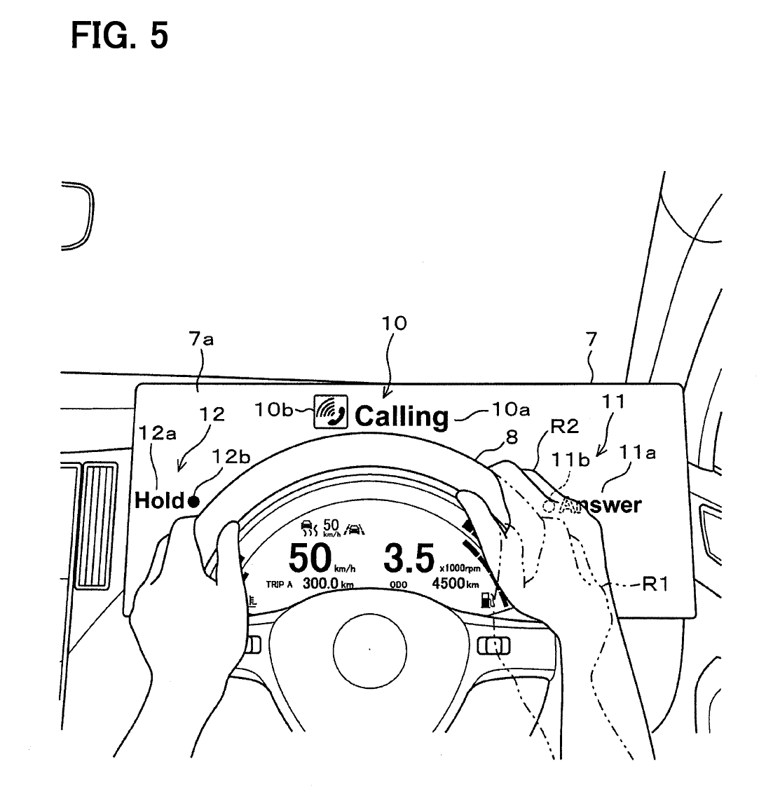

By performing the above-described processing, the controller 2 controls the display positions of the display information 11, 12 as described below. Suppose that the display positions of the display information 11, 12 are fixed at the positions shown in FIG. 3. In this case, for example, when the right hand of the driver is at the position indicated by “R1” in FIG. 3, the display information 11 is not hidden behind the driver's right hand. When the right hand of the driver moves upward from the state shown in FIG. 3 and the right hand of the driver is at the position indicated by “R2” as shown in FIG. 5, the partial display information 11 is hidden behind the driver's right hand.

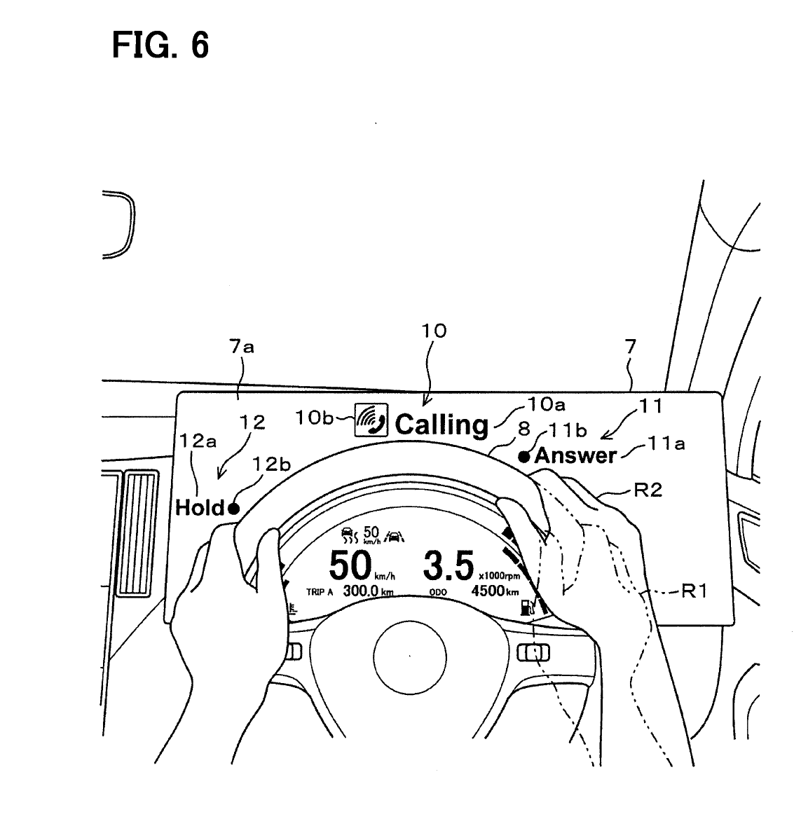

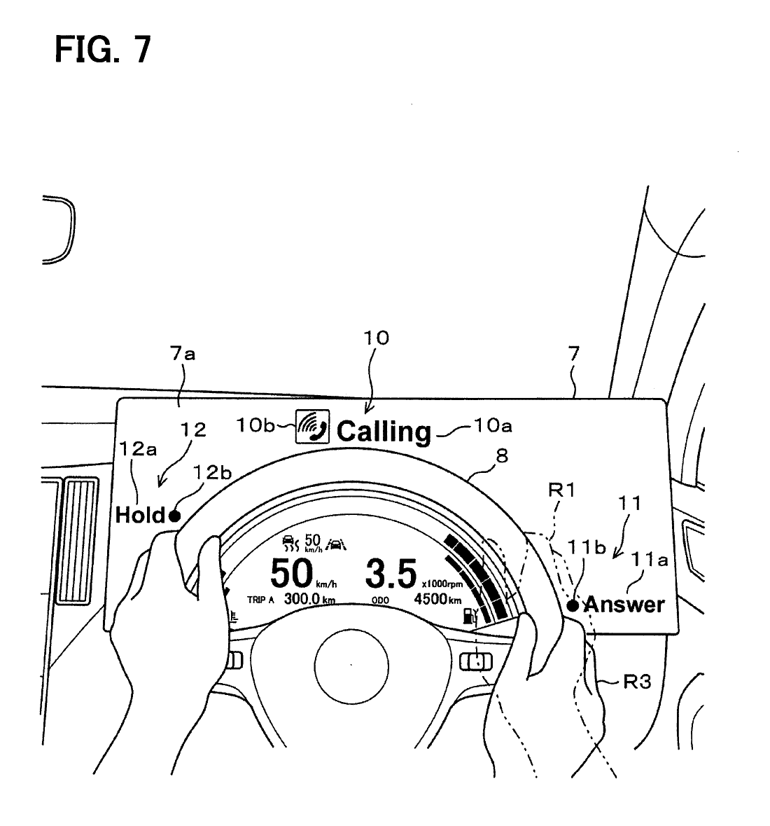

On the other hand, in the present embodiment, the display position is calculated based on the gripping position of the driver, and as shown in FIG. 6, the display information 11, 12 is displayed at the calculated display position. By changing the display position of the display information 11, 12, it is possible to avoid a situation in which the partial display information 11, 12 is hidden behind the driver's hand or the steering wheel 8. FIG. 6 illustrates the case where the display position of the display information 11 is changed upward by moving the driver's right hand upward from the state shown in FIG. 3. When the right hand of the driver moves downward from the state shown in FIG. 3, the configuration is similar thereto. When the right hand of the driver moves downward from the state shown in FIG. 3 and the right hand of the driver is at the position indicated by “R3” as shown in FIG. 7, the controller 2 changes the display position of the display information 11 downward. When the display position of the display information 11 is far from the right hand of the driver, there is a possibility that the driver feels discomfort. Thus, with the above-described configuration, by moving the display position of the display information 11 close to the right hand of the driver, it is avoided that the driver feels discomfort.

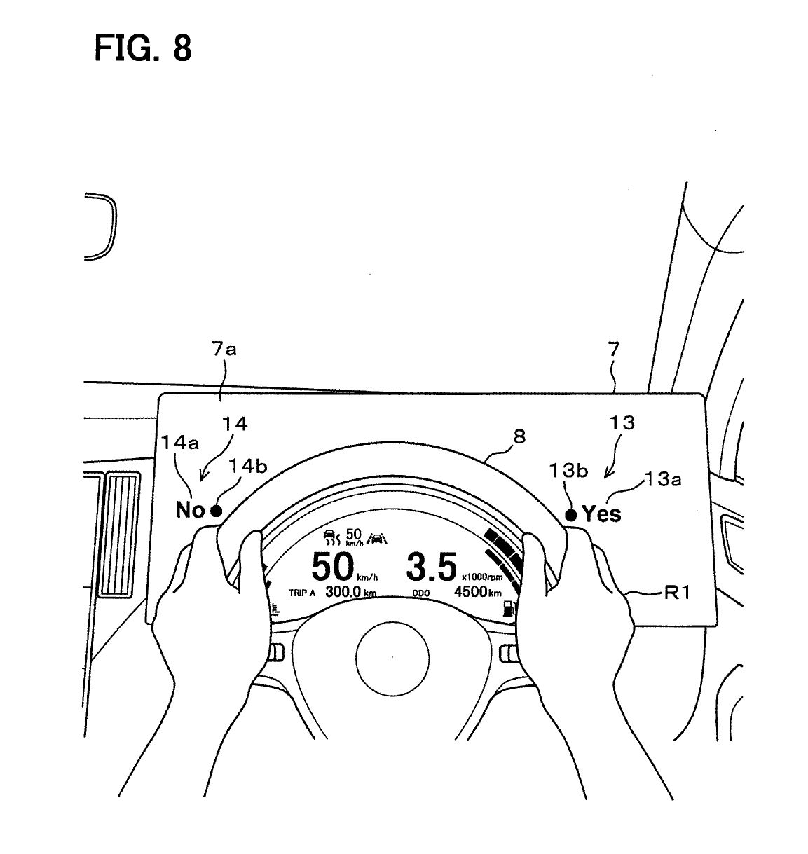

The case where the driver changes the gripping position of the right hand has been described, but the similar configuration can apply to the case where the driver changes the gripping position of the left hand. The case where the call detection signal is received from the telephone device 5 has been described as the case where the display start condition of the display information is satisfied. The similar configuration can apply to the case where the proposal signal is received from the navigation device 6. In this case, as shown in FIGS. 8 to 10, the controller 2 displays display information 13 (a character string 13a of “Yes”, and an icon 13b) indicative of the positive response to the proposal is displayed on the right of the steering wheel 8, that is, at a position corresponding to the upper right of the right hand of the driver. The controller 2 displays display information 14 (a character string 14a of “No”, and an icon 14b) indicative of the negative response to the proposal on the left of the steering wheel 8, that is, at a position corresponding to the upper left of the left hand of the driver.

The configuration described in the present embodiment can provide advantages below.

The vehicle operation system 1 calculates the display position on the meter display 7 not hidden behind the driver's hand and the steering wheel 8 using the calculation result of the gripping position at which the driver grips the steering wheel 8 and the position coordinate of the steering wheel 8, and displays the display information at the display position indicating the content of the operation on the steering wheel 8. Even when the gripping position at which the driver grips the steering wheel 8 is changed, the driver can appropriately and visually recognize the display information indicating the content of the operation on the steering wheel 8, thereby improving the convenience.

The vehicle operation system 1 displays the display information indicating a two-choice operation of the answer or the hold to the incoming call from the communication network to the telephone device 5. With this configuration, the driver can easily select to answer or hold the incoming call from the communication network to the telephone device 5. In addition, the vehicle operation system 1 displays the display information indicating a two-choice operation of the positive response or the negative response to the proposal from the navigation device 6. With this configuration, the driver can easily select the positive response or the negative response to the proposal from the navigation device 6.

Although the present disclosure has been described in accordance with the embodiments, it is understood that the present disclosure is not limited to the embodiments and structures. The present disclosure may cover various modification examples and equivalent arrangements. Furthermore, various combinations and formations, and other combinations and formations including one, more than one or less than one element may be included in the scope and the spirit of the present disclosure.

In FIG. 3 and the like, the display information 11 indicating the answer is displayed on the right of the steering wheel 8, and the display information 12 indicating the hold is displayed on the left of the steering wheel 8. Alternatively, the left and right of the display information 11, 12 may be reversed. That is, the display information 11 indicating the answer may be displayed on the left of the steering wheel 8, and the display information 12 indicating the hold may be displayed on the right of the steering wheel 8. In FIG. 8 and the like, alternatively, the display information 13 indicating the positive response may be displayed on the left of the steering wheel 8, and the display information 14 indicating the negative response may be displayed on the right of the steering wheel 8. Alternatively, the driver may select the left and right of the display information.

The gripping position is calculated after the display start condition of the display information is satisfied. Alternatively, the gripping position may be constantly calculated, and when the display start condition of the display information is satisfied, the display position may be calculated using the latest gripping position.

Alternatively, the gripping position is calculated while the display information is displayed, and the display position is calculated using the calculated gripping position. With this configuration, the display position of the display information may be changed along with the movement of the driver's hand while the display information is displayed.

Although it is exemplified that the controller 2 has the function of calculating the gripping position, the operation detector 4 may have the function of calculating the gripping position. That is, the operation detector 4 may calculate the gripping position and transmit the gripping position calculation signal indicating the calculated gripping position to the controller 2.

When the incoming call from the communication network to the telephone device 5 is detected, the display information indicating a two-choice operation of the answer or the hold to the incoming call is displayed. With this configuration, the driver can select to answer or hold the incoming call. Alternatively, the display information indicating operations other than the answer and the hold may be displayed. For example, the display information indicating a rejection operation or a transfer operation may be displayed. With this configuration, the driver may select the rejection or the transfer.

Although the telephone device 5 or the navigation device 6 is exemplified as the control target device, a device, a unit or the like connected via a vehicle network such as CAN (Controller Area Network) (registered trademark) or MOST (Media Oriented Systems Transport) (registered trademark) may be adopted. That is, for example, an advanced driving support system unit having an air conditioner, an audio device, a lane keep function or the like, or an autonomous driving system unit having an automatic accelerator control function, an automatic brake control function or the like may be adopted as the control target device. In the air conditioner, a character string of “Up” or a character string of “Down” may be displayed in response to a proposal for adjusting the set temperature or the set air volume, for example. In the audio device, a character string of “Up” or a character string of “Down” may be displayed in response to a proposal for adjusting the set volume, for example. In the advanced driving support system unit, a character string of “Yes” and a character string of “No” may be displayed in response to a proposal for starting or terminating the advanced driving support. In the autonomous driving system unit, a character string of “Yes” and a character string of “No” may be displayed in response to a proposal for starting or terminating the autonomous driving.

1. A vehicle operation system configured to control a control target device based on a predetermined operation of a driver on a steering wheel of a vehicle, the vehicle operation system comprising:
a gripping position calculation unit configured to calculate a gripping position at which the driver grips the steering wheel;
a display position calculation unit configured to calculate a display position on a display using a calculation result of the gripping position calculation unit and a position coordinate of the steering wheel, the display arranged farther than the steering wheel from a visual line position of the driver, and the display position not hidden behind a hand of the driver and the steering wheel; and
a display control unit configured to display display information indicating a content of the operation on the steering wheel at the display position.

2. The vehicle operation system according to claim 1, wherein
the display position calculation unit calculates the display position corresponding to an upper part of the gripping position.

3. The vehicle operation system according to claim 1, wherein:
the gripping position calculation unit calculates a right hand gripping position at which the driver grips the steering wheel with a right hand, and a left hand gripping position at which the driver holds the steering wheel with a left hand;
the display position calculation unit calculates a right side display position that is not hidden behind the right hand of the driver and the steering wheel, and a left side display position that is not hidden behind the left hand of the driver and the steering wheel; and
the display control unit displays the display information indicating one of a plurality of selection operations at the right side display position, and displays the display information indicating another one of the plurality of selection operations at the left side display position.

4. The vehicle operation system according to claim 3, wherein:
the control target device has a telephone function;
the display control unit displays the display information indicating one of the plurality of selection operations at the right side display position, and displays the display information indicating another one of the plurality of selection operations at the left side display position; and
the plurality of selection operations are provided for an incoming call to the control target device.

5. The vehicle operation system according to claim 3, wherein:
the control target device has a proposal function;
the display control unit displays the display information indicating one of the plurality of selection operations at the right side display position, and displays the display information indicating another one of the plurality of selection operations at the left side display position; and
the plurality of selection operations are provided for a proposal from the control target device.

6. A non-transitory tangible computer readable storage medium comprising instructions executed by a processor of a vehicle operation system, the vehicle operation system configured to control a control target device based on a predetermined operation of a driver on a steering wheel of a vehicle,
the instructions comprising:
calculating a gripping position at which the driver grips the steering wheel;
calculating a display position on a display using a calculation result of the gripping position at which the driver grips the steering wheel and a position coordinate of the steering wheel, the display arranged farther than the steering wheel from a visual line position of the driver, and the display position not hidden behind a hand of the driver and the steering wheel; and
displaying display information indicating a content of the operation on the steering wheel at the display position.

7. A vehicle operation system configured to control a control target device based on a predetermined operation of a driver on a steering wheel of a vehicle,
the vehicle operation system comprising a processor configured to:
calculate a gripping position at which the driver grips the steering wheel;
calculate a display position on a display using a calculation result of the gripping position at which the driver grips the steering wheel and a position coordinate of the steering wheel, the display arranged farther than the steering wheel from a visual line position of the driver, and the display position not hidden behind a hand of the driver and the steering wheel; and
display display information indicating a content of the operation on the steering wheel at the display position.
